(19) United States
(12) Patent Application Publication
(10) Pub. No.: US 2008/0187625 A1
(43) Pub. Date: Aug. 7, 2008

(54) Process For Preparing a Bacterial Culture, and the Product Prepared by the Process

(76) Inventors: Eirik Selmer-Olsen, Son (NO); Juan Abrahamsen, As (NO); Terje Sorhaug, As (NO)

Correspondence Address: YOUNG & THOMPSON, 209 Madison Street, Suite 500, ALEXANDRIA, VA, 22314, US

(21) Appl. No.: 11/667,357

(22) PCT Filed: Nov. 14, 2005
(86) PCT No.: PCT/NO05/00428

§ 371 Date: Sep. 28, 2007

(30) Foreign Application Priority Data
Nov. 15, 2004 (NO) 20044967

(51) Int. Cl. A23C 9/12

(52) U.S. Cl. 426/43; 426/61

(57) ABSTRACT

The invention relates to a process for preparing a product containing a bacterial culture, wherein oleic acid is added during the process, and to the product prepared by the process. The process according to the invention will result in increased survival of microorganisms in the product, which includes feed, and in the digestive system of humans and animals. The present invention relates to the fact that bacteria which are exposed to oleic acid during growth have increased survival when subjected to bile salts and extreme pH values.

The present invention relates to a process for preparing a bacterial culture, and to the product prepared by the process. The process according to the invention will result in increased survival of microorganisms in the product, which includes feed, and in the digestive system of humans and animals. The beneficial effect is believed to be achieved by subjecting microorganisms to a culture medium to which pure oleic acid (C18:1) or oleic acid as a major part of a lipid fraction has been added.

In recent years there has been an increased focus on food in relation to health. Terms such as “functional food” and “neutraceutical” are closely associated with health and have a substantial influence on research and development in the food industry. To date, it is probiotic products that have been the greatest focus of attention in this segment.

A probiotic product should contain a mono- or mixed culture of living microorganisms which, when ingested by animals or humans, beneficially affect the host by improving the properties of the host's natural microflora. There is a growing focus on the importance of probiotic lactobacilli for health in general, and it is first and foremost in connection with positive effects on the digestive system that the interest in probiotics is greatest.

For the bacteria to have a beneficial effect on the health of the host, they must be capable of surviving and preferably of colonising the gut. To be able to colonise the gut, the microorganisms must be capable of surviving through the digestive system, which involves exposure to hydrochloric acid in the stomach and bile in the small intestine. Another challenge related to probiotic products is the survival of microorganisms during processing and in the finished product until the use-by date.

In order that probiotic products should be effective and potent, a relatively high intake of bacteria (10⁹ cells/day) is recommended. This means that it is a challenge to get the microorganisms to survive in the product for a sufficient length of time. Probiotic bacteria are often isolated from the gut, and they often have different nutritional requirements than the traditional microorganisms that are used in commercial fermentation. In addition to being difficult to get to grow in, for example, milk, probiotic intestinal bacteria may during growth give the product a characteristic flavour that is undesirable. To avoid the characteristic flavour and the addition of growth components to the milk, the probiotic microorganisms can be added in the desired concentration to the finished processed product. Most probiotic products on the market are fermented products, where the probiotic bacteria either are a part of the fermentation culture or they are added after fermentation is completed and the product has been cooled.

The problem with probiotics is, as mentioned, to obtain sufficient survival of bacteria in the intestinal system. A number of approaches to increase this survival have been suggested. Among them, the selection of microorganisms that are resistant to acid and bile salts is probably the most common method. Other methods that have been described are microencapsulation and stress adaptation. In stress adaptation of the bacteria, the focus is primarily on the bacteria being more robust against low pH. The methods used to render the bacteria more robust against low pH values include subjecting the bacteria to thermal shock (stress proteins) or culturing the microorganisms under slightly acid pH values (acid adaptation).

U.S. Pat. No. 5,580,000 relates to the substitution of butterfat with vegetable oils rich in oleic acid with the object of making the milk healthier with regard to cardiovascular disease. As mentioned, the beneficial health effects of oleic acid are not the basis of the present invention. The present invention, as described above, relates to the fact that bacteria which are exposed to oleic acid during growth have increased survival when subjected to bile salts and extreme pH values. These are properties which are of crucial importance for probiotic products.

In this patent we render the bacteria more robust against extreme pH values and exposure to bile salts by adding oleic acid to the culture medium. Tests we have done show that Lactobacillus rhamnosus cultured on MRS (De Man Rogosa Sharpe) medium with oleic acid added to it in different concentrations, has increased survival at low pH and at different concentrations of bile salts. The lactobacillus was cultured in a culture medium with pure oleic acid added to it in the following concentrations: 0.25%, 0.5% and 1.0% (w/v). After being cultured for 24 hours, it was exposed to pH 3.5 and bile salt concentrations of 0.25%, 0.5%, 1% and 2% (w/v). The effect of oleic acid on the survival of Lactobacillus rhamnosus against different concentrations of bile salts is shown in FIG. 1. The survival of Lactobacillus rhamnosus when exposed to pH 3.5 is shown in Table 1. Lactobacillus rhamnosus shows increased survival against bile salts with an increasing concentration of oleic acid. There was also an increase in the survival of Lactobacillus rhamnosus at the pH in question.

Thus, the present invention relates to a process for preparing a product containing a bacterial culture, wherein the process comprises the steps of
i) providing a fermentation medium with bacteria added to it; and
ii) fermenting the fermentation medium in i),

characterised in that oleic acid is added in step i) or ii).

The invention also relates to a process for preparing a bacterial culture, wherein the process comprises the steps of

i) providing a culture medium with bacteria added to it;

ii) culturing the bacteria in the culture medium; and

iii) concentrating the product obtained in ii),

characterised in that oleic acid is added in step i) or step ii).

In addition, the invention relates to a product prepared by the processes according to the invention.

An example of the production of microorganisms subjected to oleic acid may comprise the following steps:
(i) Production of a fermentation medium to which oleic acid is added.
(ii) Adding bacteria to the fermentation medium from (i), culturing to the desired cell density and harvesting by centrifugation or filtration.
(iii) Concentrating bacteria by the following methods:
   a) Freeze drying
   b) Spray drying
   c) Membrane filtration.
(iv) Adding concentrated culture to the product. The product may be a food, a feed, a capsule or a pill.

The composition of the fermentation media varies depending on what microorganisms it is desired to produce. A common feature of the media is that they are supplemented with free oleic acid or fat/oils having a major portion of oleic acid. The concentration of oleic acid in the culture medium varies depending on the microorganisms and the culture medium.

Different sources can be used as the oleic acid source. Oleic acid may either be present as a monoglyceride or as a part of a di- and/or triglyceride. The said glycerides may be of animal or vegetable origin. Examples include butterfat, fractions of butterfat, fish oil from various species of fish, olive oil, rape seed oil etc. Both fractions from animal and vegetable oil/fat and the fat/oil itself can be added to the fermentation medium. To increase the oleic acid content of the different oils/fats, it may be necessary to hydrolyse some of them.

In certain cases it may be necessary to emulsify the oleic acid or the substances containing the oleic acid. In tests oleic acid was emulsified using lecithin. It is also possible to use other emulsifiers, including components from buttermilk.

Commercial culture media which are more or less tailored to the different microorganisms have been used in tests. For example, MRS with added oleic acid has been used for lactobacilli, and sodium lactate medium has been used for propionic acid bacteria. For industrial production it is normal to use culture media that are less expensive than commercial laboratory media. These may be media based on milk, meat, fish, fruit/berries or vegetables. They may also be fractions or by-products from the processing of the said raw materials.

The media are sterilised, either by heat or filtration, with or without fat/oil/oleic acid. If fat/oil/oleic acid is not added prior to sterilisation, it is sterilised before it is added to a sterile medium.

The conditions for the preparation of the microorganisms that are to be cultured are determined on the basis of the respective microorganisms and the environment in which they are to have increased survival. The microorganisms are inoculated at an inoculation percent of from 0.1 to 5%.

The concentration method to be used is determined on the basis of the microorganism, the environment in which the microorganism is to function and the environment in which the microorganism is transported to the site of action. On freeze drying, drying and optional freezing, osmo-/cryoprotectants can be used to protect the microorganisms. Typical protectants that are suitable include glycerol, cysteine, sucrose and skimmed milk.

The concentration of microorganisms by using spray drying is a good alternative. Spray drying is suitable for concentrating lactobacilli and bifidobacteria. In the same way as for freeze drying, it is important that the microorganisms are protected optimally against the stresses to which they are subjected, both in the dehydration step and also in the subsequent rehydration step before use.

The microorganisms are cultured in traditional fermenters or they can be cultured and concentrated in a filter fermenter in accordance with Norwegian Patent No. 174589. In what follows, the invention will be explained in more detail by means of an example. The example is merely an embodiment of the present invention, and the invention is therefore not limited to that disclosed in the example.

Composition of the culture medium:
a) 10% (w/v) skimmed milk powder
b) 0.25% oleic acid
c) Whey protein hydrolysate

10% (w/v) of skimmed milk is mixed with the oleic acid and processed in a microfluidiser to emulsify the oleic acid. Hydrolysed whey protein and the rest of the skimmed milk are mixed together with the emulsion and heat-treated using UHT treatment (125-138° C. for 2-4 seconds).

The fermentation medium is heated to 37° C. in a filter fermenter. Addition of bacteria, 2%.

Production and concentration of the bacteria to a density of 10¹¹⁻¹² cells/ml. The fermentation medium is cooled and has added thereto ready fermented yoghurt to a cell concentration of 10⁸ cells/ml

TABLE 1
Survival of Lactobacillus rhamnosus at pH 3.5.

| Time | Oleic | | | |
|---|---|---|---|---|
| (hrs) | acid 0% | Oleic acid 0.25% | Oleic acid 0.5% | Oleic acid 1.0% |
| 0 | 7.44 | 7.55 | 7.59 | 7.53 |
| 1 | 7.44 | 7.55 | 7.60 | 7.55 |
| 3 | 7.45 | 7.57 | 7.64 | 7.57 |
| 24 | 7.47 | 7.57 | 7.65 | 7.61 |

1. A process for preparing a product containing a bacterial culture, wherein the process comprises the steps of
i) providing a fermentation medium with bacteria added to it; and
ii) fermenting the fermentation medium in i),
characterised in that oleic acid or butterfat fraction containing oleic acid is added in step i).

2. A process for preparing a product containing a bacterial culture, wherein the process comprises the steps of
i) providing a fermentation medium with bacteria added to it; and
ii) fermenting the fermentation medium in i),
characterised in that oleic acid or butterfat fraction containing oleic acid is added in step ii).

3. A product, characterised in that it is prepared according to the process of claim 1.

4. A product, characterised in that it is prepared according to the process of claim 2.
